(19) United States
(12) Patent Application Publication
(10) Pub. No.: US 2007/0174438 A9
(43) Pub. Date: Jul. 26, 2007

(54) Notification system

(76) Inventors: Daniel T. Johnson, Medina, MN (US); James W. Peterson, Lake Elmo, MN (US); Robert S. McConnell, Woodbury, MN (US); Frank C. Brown III, Blacksburg, VA (US)

Correspondence Address: Sean D. Solberg;DORSEY & WHITNEY LLP, Intellectual Property Department, Suite 1500, 50 South Sixth Street, Minneapolis, MN, 55402-1498, US

(21) Appl. No.: 10/734,725

(22) Filed: Dec. 12, 2003

Related U.S. Application Data
(63) Continuation-in-part of application No. 10/429,619, filed on May 5, 2003.
(63) Continuation-in-part of application No. 09/883,779, filed on Jun. 18, 2001.
(60) Provisional application No. 60/433,179, filed on Dec. 13, 2002.
(60) Provisional application No. 60/432,120, filed on Dec. 9, 2002.
(60) Provisional application No. 60/212,234, filed on Jun. 16, 2000.
(60) Provisional application No. 60/288,827, filed on May 5, 2001.

(51) Int. Cl. G06F 15/173

(52) U.S. Cl. 709/223

(57) ABSTRACT

A system for receiving and normalizing notification events from assets or equipment located at various sites within an enterprise is disclosed. The system includes receiving a notification, identifying the protocol used by the equipment sending the notification, and converting the notification to a normalized format. The system allows notifications from various types of equipment or assets to be handled by one enterprise management system.

### CROSS-REFERENCE TO RELATED APPLICATION

This application claims priority to U.S. Provisional Application No. 60/433,179, filed on Dec. 13, 2002, the contents of which is hereby incorporated by reference herein in its entirety.

### BACKGROUND OF THE INVENTION

The present invention relates to an asset or equipment notification system. More specifically, the present invention relates to an asset notification system for use with asset management system.

It is frequently useful to track notification or alarm events from equipment or assets for reasons including satisfying service and maintenance needs for the equipment. Especially for larger entities with assets distributed in various locations or sites, it is beneficial to track information for any given asset among hundreds of similar assets owned by a company.

A typical notification system involves a human operator receiving a maintenance request, interpreting the request, creating a work order related to the request, and contacting a service provider to resolve the maintenance or service need. Several different communication protocols are used by the various types of equipment or assets located at various sites. The typical system is inefficient and error-prone. Each notification requiring interaction with a human operator and manual interpretation of the request consumes resources and is susceptible to human error. Further, the unique protocols across systems create inefficiencies when attempting to address requests from more than one system.

There is a need in the art for a centralized system for efficiently receiving and addressing maintenance or service requests for assets. There is also a need for a service request system that allows for the assimilation and use of maintenance or service requests from more than one different asset management system. Further, there is a need for a service request system that reduces errors and maximizes efficiency. Finally, there is a need for a service request system that reduces susceptibility to human error.

### BRIEF SUMMARY OF THE INVENTION

The present invention, in one embodiment, is a central asset management system including a central processor configured to track information from a plurality of unique notification systems. This information is relevant to managing each of a plurality of assets of a plurality of enterprises. The system further includes a notification processor configured to standardize the information from each of the plurality of unique notification systems, whereby the information is compatible with the central processor, and a database configured to store asset information for the plurality of assets, the database in communication with the central processor.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram showing the various components of the service request processing system, according to one embodiment of the present invention.

FIG. 2 is a flow diagram of a method and system of notification processing, according to one embodiment of the present invention.

FIG. 3 is a flow diagram of a standardization process, according to one embodiment of the present invention.

FIG. 4 is a chart of exemplary notification information.

FIG. 5 is a flow diagram of a method of processing the standardized notification information with an asset management system, according to one embodiment of the present invention.

FIG. 6 is a block diagram showing the various components of a service request processing system, according to an alternative embodiment of the present invention.

FIG. 7 is a flow diagram of a method and system of notification processing, according to an alternative embodiment of the present invention.

FIG. 8 is a block diagram showing the various components of a notification processing system, according to a further alternative embodiment of the present invention.

FIG. 9 is a flow diagram of a method and system of notification processing, according to a further alternative embodiment of the present invention.

FIG. 10 is a flow diagram of a method and system of notification processing, according to another alternative embodiment of the present invention.

### DETAILED DESCRIPTION

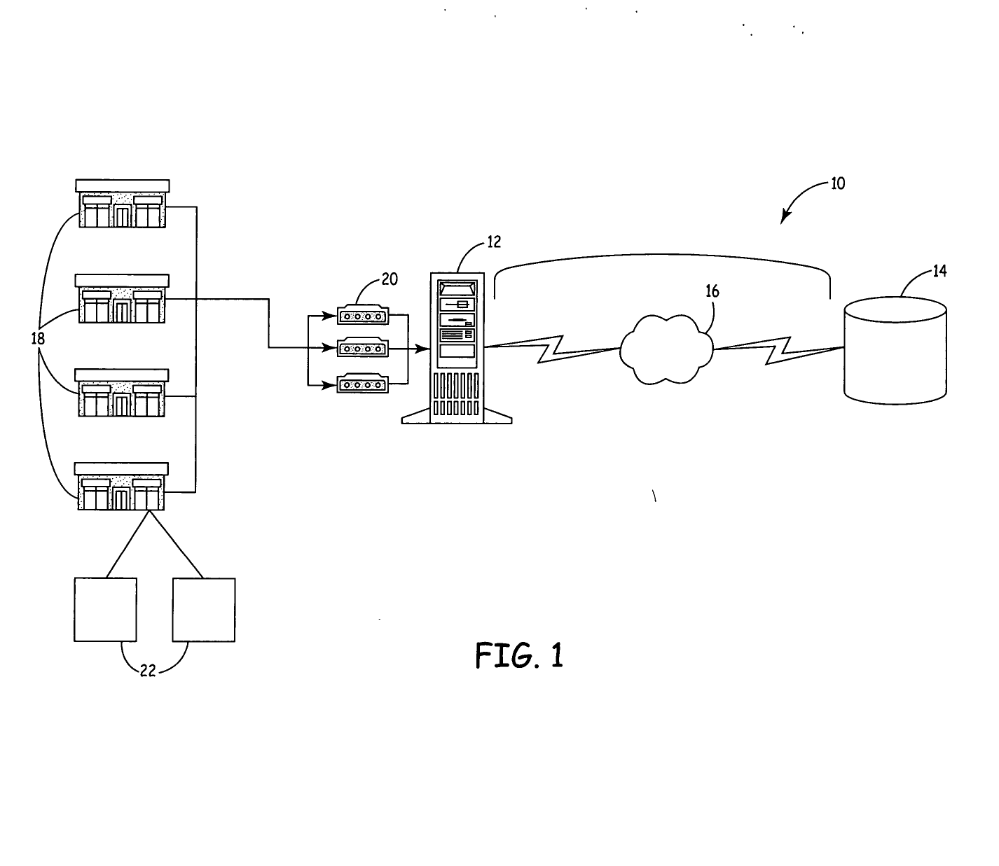

FIG. 1 shows an embodiment of a notification system 10 in accordance with one embodiment of the subject invention. This embodiment is comprised of a notification processor 12 connected via a network 16 to an asset management system 14. In one embodiment, the network 16 is the Internet. The notification processor 12 is also connected to a plurality of client processors 18 located at a plurality of client sites. In one aspect of the invention, each client site is a location having a plurality of assets requiring observation and potentially, maintenance. The client processors 18 are connected to the notification processor 12 through one of a plurality of modems 20. Alternatively, the client processors 18 are connected over the Internet to the notification processor 12. One embodiment of the present invention, is a notification translator not including an asset management system. One embodiment of such a notification system is further described in Attachment “A,” which is hereby incorporated by reference in its entirety.

In some embodiments, asset interfaces 22 are attached to assets with communications capabilities in order to monitor and/or control its performance. It is common for certain assets to have ports through which notification regarding performance characteristics and/or failure signals can be obtained. According to one aspect of the invention, the asset interfaces 22 may be sensors that track the operational status of the asset and transmit notifications when an operational issue arises. Alternatively, some assets may have bi-directional communication capabilities that enable the asset to be monitored and operated remotely. Each asset interface 22 can be configured to communicate with the asset and to provide a communication link between the asset and a client processor 18 or the notification processor 12.

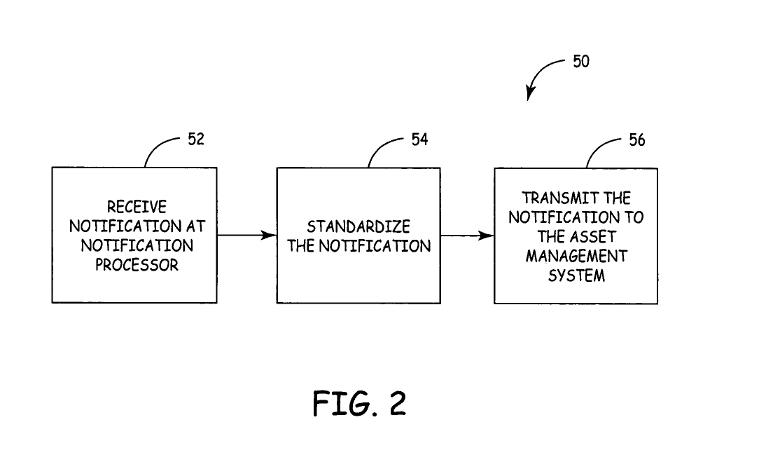

As shown in FIG. 2, the system and method of notification processing 50 generally comprises receiving a notification from a client processor or asset interface at the notification processor (block 52), standardizing the notification (block 54), and transmitting the notification to the asset management system (block 56). Alternatively, the notification is not standardized, because it is already in a language compatible with and understandable by the asset management system. The notification is a request to provide service to a particular asset. Alternatively, notification is notification that an asset has an operational issue requiring attention. One type of notification, for example, is a service request.

Upon receiving the notification (block 52), the system of the present invention according to one embodiment standardizes the notification (block 54). That is, the request language (also referred to as the request code or request protocol) unique to the asset or client processor 18 is converted into a language compatible with and understandable by the asset management system 14. According to one embodiment, the standardization of the request language is performed by standardization or translation software. The translation software is located at the notification processor 12. Alternatively, the translation software is located at the asset management system 14. After standardization (block 54), the standardized notification information is transmitted to the asset management system (block 56) for processing. Alternatively, if the standardized information is already at the asset management system, the processing of the standardized information begins.

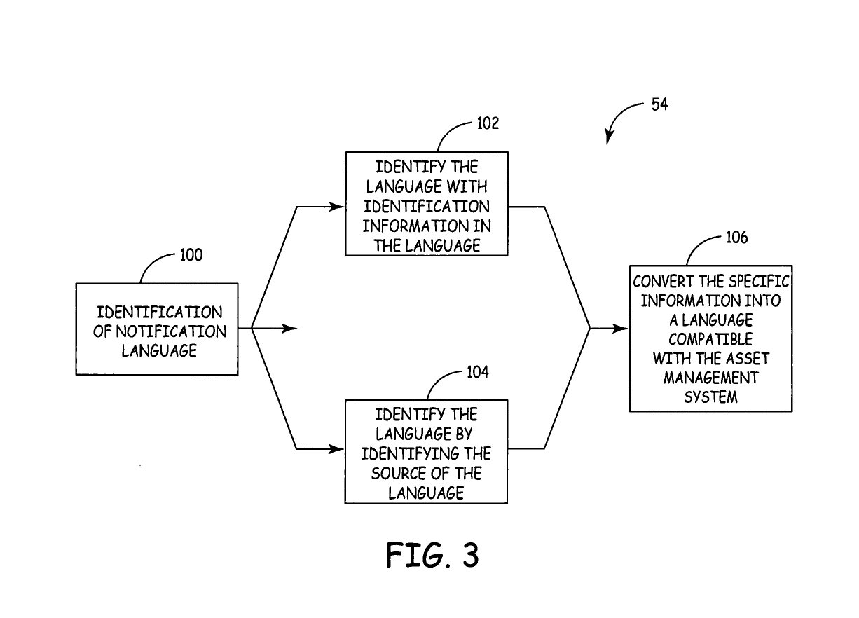

As shown in FIG. 3, the standardization process 54 in accordance with one aspect of the invention involves identification of the notification language (block 100). According to one embodiment of the present invention, the system identifies the notification language by receiving identification information provided within the notification language itself (block 102). Alternatively, the notification language is identified by identifying the source of the notification language (block 104). If the notification is transmitted to a modem over a network such as a phone line, the source can be identified by identifying the source phone number. Alternatively, if the notification is transmitted via the Internet, the source can be identified by identifying the I.P. address. Once the language has been identified (block 100), the system converts the specific notification information into a language that is compatible with the asset management system (block 106).

In one embodiment, the notification information is used for other purposes, such as, for example, tracking the temperature that a particular food item is stored at over a given period of time. In a further example, the notification information is used to assist in the tracking and repair of refrigerant loss.

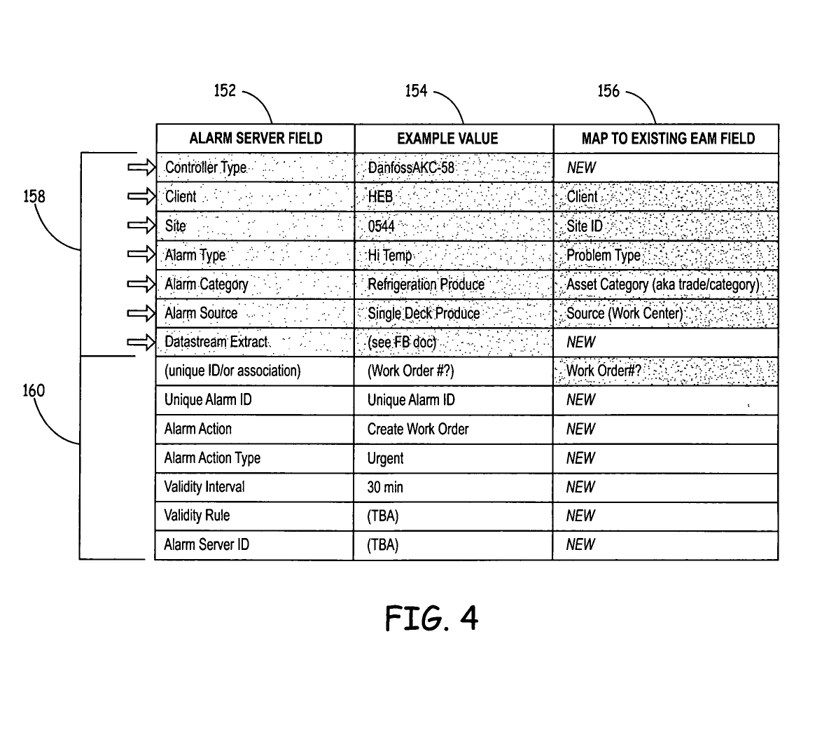

FIG. 4 is a representation of the type of notification information 150 that is standardized, according to one embodiment of the invention. Regardless of the type of notification system present at the client, the notification will contain certain basic information 158 that is required to process the notification. According to one embodiment, the basic information fields 152 may include controller type (the type of notification system at the client site), client name, site identification, type of problem creating the service request, category of asset experiencing the problem, and the source asset. Using the standardization or translation software, the values 154 in each of the basic information fields 152 are converted into a language that is compatible with the asset management system and dropped into the appropriate existing asset management system field 156. In some embodiments, additional fields 160 are also created or derived when the information is received at the translator. In one embodiment, the translator is located at the site, or at a central location receiving signals from multiple sites. In another embodiment, the translator is located on the asset management system server.

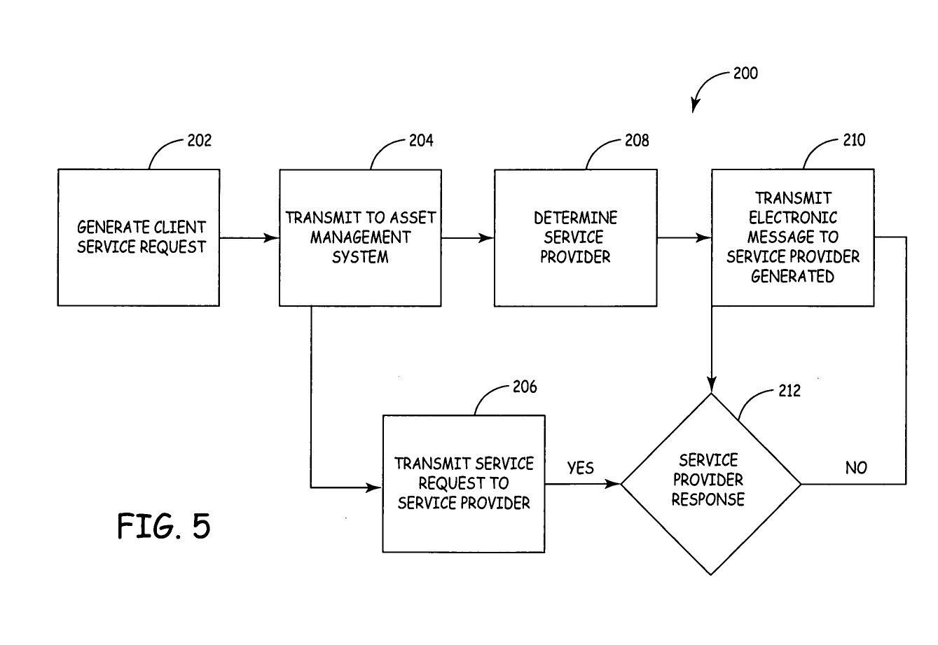

After the notification has been standardized, the present invention includes a method and system of processing the standardized notification information with an asset management system 200, as shown in FIG. 5. One such asset management system is disclosed in co-pending U.S. patent application Ser. No. 09/883,779, entitled “Method and System for Managing Enterprise Assets,” filed on Jun. 18, 2001, which is incorporated herein by reference in its entirety. The method generally comprises generating a service request (block 202) based on the notification information, transmitting the service request to the asset management system (block 204), determining a service provider (block 208), and generating and transmitting an electronic message to the designated service provider (block 210). Alternatively, information regarding the appropriate service provider may be provided in the service request such that the service request can be automatically transmitted directly from the asset management system to the service provider (block 206) without the additional service provider determination step. In a further alternative, the system of the present invention awaits the service provider's response (block 212), and can re-transmit the message or select a different service provider if there is no response from the service provider.

In one embodiment, a variety of data fields are added to the asset management system. Examples of types of data fields that may be added are shown in Attachment “B,” which is incorporated herein by reference in its entirety. Example of various types of equipment that may be worked into the asset management system are shown in Attachment “C,” which is incorporated herein by reference in its entirety.

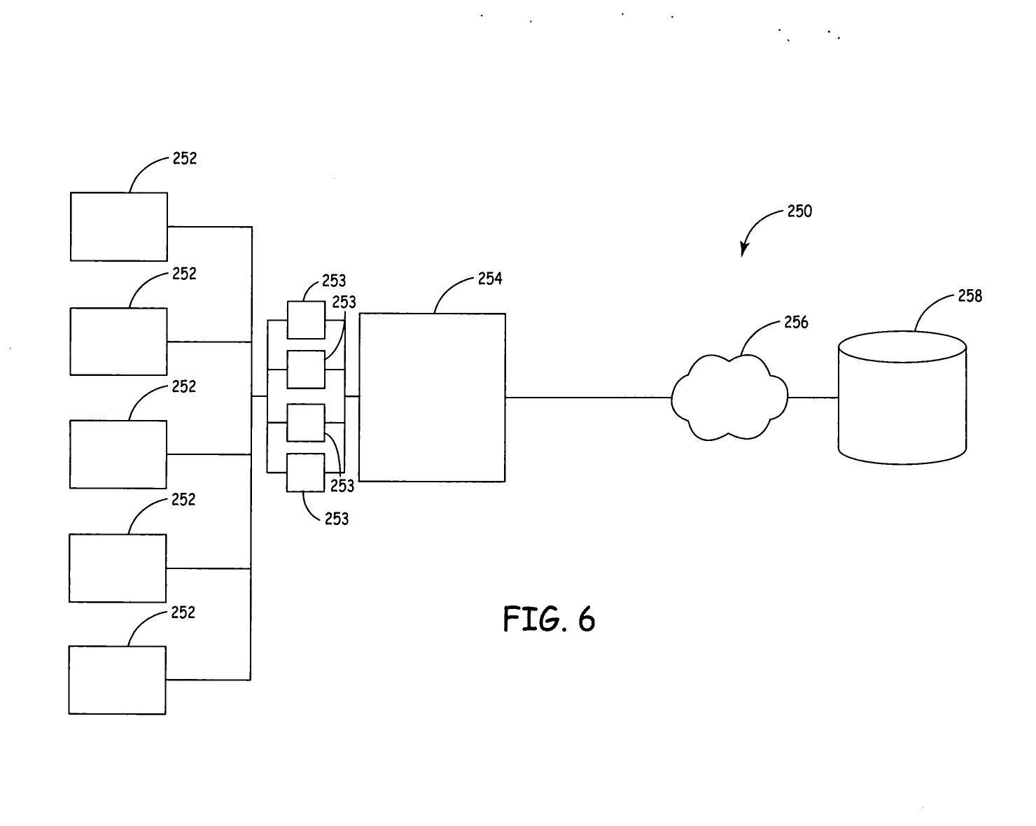

FIG. 6 depicts an exemplary embodiment of a notification system 250 according to one embodiment of the present invention. The notification system 250 in this embodiment is utilized in coordination with an alarm server component of an asset management system, wherein the assets are refrigeration units at various clients. Alternatively, the assets can be any known equipment for which operational information can be tracked and alarms can transmitted. Each client has a refrigeration control system 252 that is connected to the notification processor or “alarm server” 254 via a set or “stack” of modems 253. That is, the control system 252 connects via the modem 253 amongst the set of modems with which the system 252 is compatible. Alternatively, each system 252 is connected to the notification processor 254 via any known means of connection. It is understood that there are several different refrigeration control systems 252 available in the industry and thus there may be several different control systems 252 with different compatibilities communicating with the notification processor 254. As a result, the stack of different modems 253 ensures that, for each refrigeration control system 252, there is a compatible modem 253 available. The notification processor 254 is connected to the asset management system 258 over a network 256. According to one embodiment, the network 256 is the Internet.

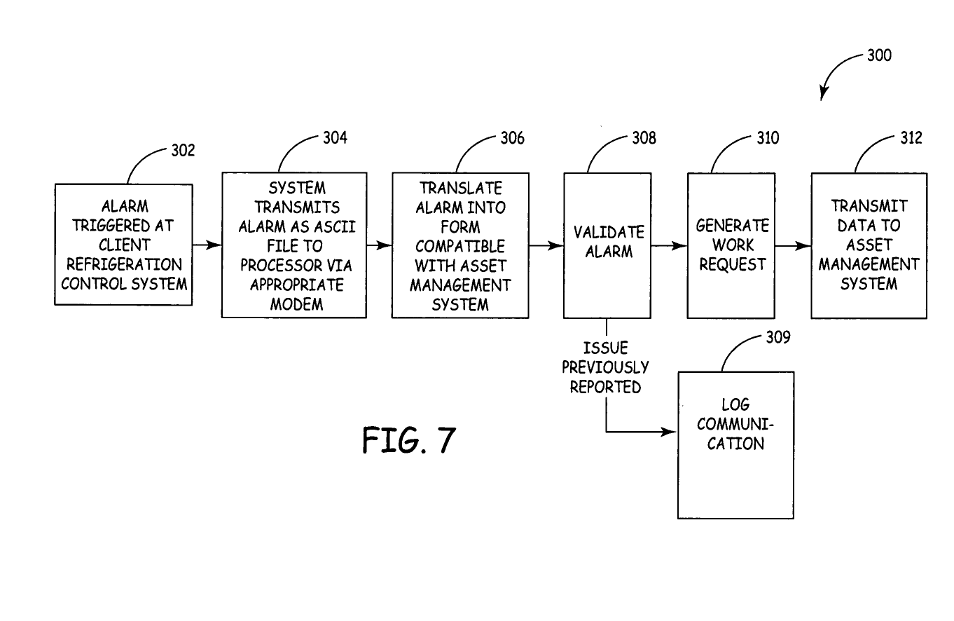

FIG. 7 depicts the method of alarm processing 300, according to one embodiment of the invention, using the system depicted in FIG. 6. The method is activated when an alarm is triggered at a client's refrigeration control system (block 302). That is, information being tracked at the client indicates that some operational problem or situation requiring attention has occurred. The client system 252 transmits the notification or alarm as an ASCII file to the notification processor 254 via an appropriate modem 253 (block 304). Alternatively, the notification is in any known form for electronic communication. The alarm is transmitted to the processor 254 via a particular modem 253 based on compatibility between the client system 252 and the modem 253. Upon transmission, the alarm is translated by the processor 254 into a form compatible with the asset management system 258 (block 306). In addition, the alarm is validated (block 308). That is, based on information available to the processor 254, it is determined whether this alarm is related to an operational issue that has already been reported. If the issue has already been reported, the alarm is merely logged (block 309) and no further action is taken. If not, the processor 254 generates a work request and other data in a format compatible with the asset management system 258 (block 310) and the data is transmitted to the asset management system 258 (block 312).

The data transmitted to the asset management system 258 can include, but is not limited to, any of the following information, including temperature of refrigeration unit exceeding set limit, temperature of refrigeration unit below set limit, door of refrigeration unit is open, refrigeration unit is not operating, or any other known condition that may require an alert. Alternatively, the asset is any known operating asset and the data transmitted is any known data that may call for an alert.

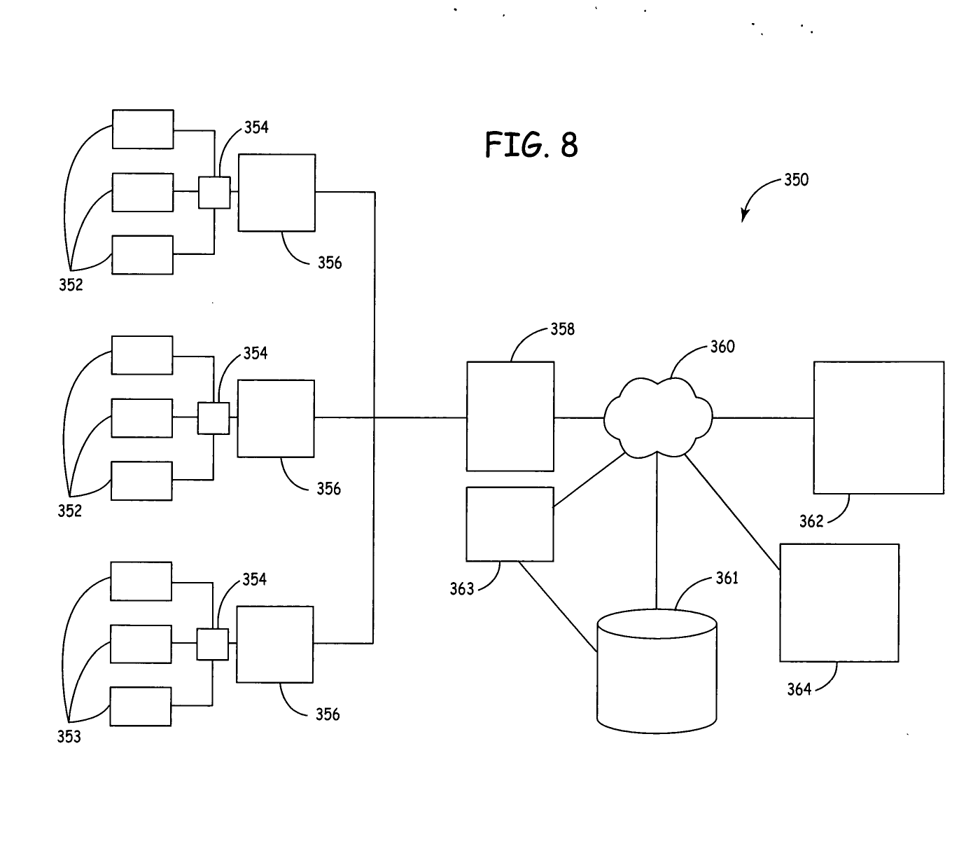

FIG. 8 depicts a further exemplary embodiment of a notification system 350 according to an alternative embodiment of the present invention. The notification system 350 in this embodiment utilizes both inbound and outbound notifications. According to one embodiment, the notification system of this embodiment could be utilized in coordination with a refrigerant leakage tracking and repair component of an asset management system. One example of a refrigerant leakage tracking and repair system is disclosed in U.S. patent application Ser. No. 10/429,619, filed on May 5, 2003 and claiming priority to U.S. patent application Ser. No. 60/432,120, filed on Dec. 9, 2002, both of which are hereby incorporated herein by reference in their entirety. Alternatively, the system could be utilized in coordination with an asset maintenance component of an asset management system. In a further alternative, the component could be tracking any known leakage or other operational issues related to client assets such as air conditioning units, etc.

As shown in FIG. 8, each client has entry computers 353 that are directly connected to the client control processor 356. In accordance with one embodiment, each client also has refrigeration units 352 that are connected to the client control processors 356 through asset/equipment interfaces 354. The client processors 356 are connected to the notification processor 358. The notification processor 358 is connected to a database 361, an asset management processor 363, an owner/operator 362, and to at least one service provider 364 over a network 360. Further, in accordance with one aspect of the invention, the database 361 is connected directly to the asset management processor 363. According to one embodiment, the network 360 is the Internet. According to one embodiment, the boxes 362, 364 representing the owner/operator 362 and the service provider 364 are computers or computer processors 362, 364 at each of the owner/operator and the service provider 364. Alternatively, the boxes 362, 364 represent phones, e-mail inboxes, or any other known means for receiving notifications in any medium.

According to one embodiment, the three client computers 353 represents three client computers 353 at three different clients. Alternatively, each of the three computers 353 can be three computers 353 at three different sites or locations of one client. In a further alternative, each of the three computers 353 is associated with a different system at the same client.

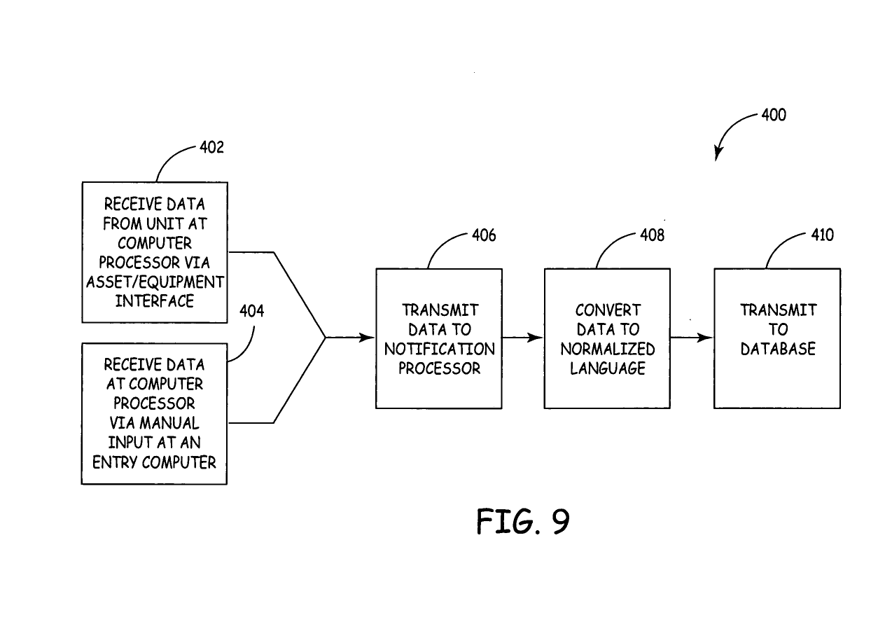

FIG. 9 depicts the method of providing inbound notifications 400, according to one embodiment of the invention, using the system depicted in FIG. 8. According to the method, data relating to the asset is received at the client computer. According to one embodiment, this information is received directly from the asset or unit via the asset/equipment interface 354 (block 402). Alternatively, the information is received via entry of service details or work order details by a service provider or data entry at an entry computer 353 (block 404). The data is transmitted from the client control computer 356 to the notification processor 358 (block 406). According to one embodiment, the data is then converted into normalized language (block 408). That is, the data is translated into a form that is understandable at the database 361 or anything else that may receive the information from the processor 358. The data is then transmitted to the database 361 (block 410).

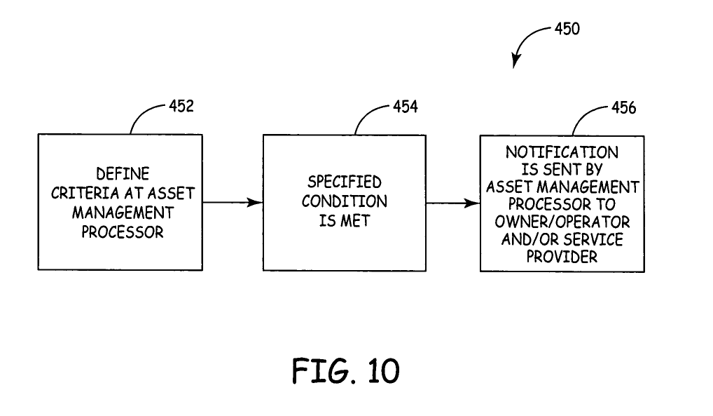

FIG. 10 depicts the method of providing outbound notifications 450, according to one embodiment of the invention, using the system depicted in FIG. 8. Data relating to the asset is collected at the database 361. According to one embodiment, the data relates to refrigerant leakage rates. Alternatively, the data relates to any maintenance-related or operational data relating to an asset that may be updated, tracked, or require oversight. According to the method, certain criteria are defined at the asset management processor 363 (block 452). That is, the processor 363 is configured to track certain data in the database 361. The criteria may be fixed criteria or, alternatively, may be definable by the user. At some point, a specified condition is met (block 454). That is, the processor 363 identifies certain data indicating that a pre-defined condition has been met. As a result, a notification is sent by the processor 363 to the owner/operator 362 or the service provider 364 (block 456). Notification may be take the form of an e-mail, a fax, a pager communication, an automated voice communication via telephone, an electronic communication to another system, processor, or computer, or any other known form of electronic message. Alternatively, the notification can be any communication of interest relating to asset information. The notification can be, for example, a work order transmitted to the service provider 264. According to one alternative embodiment, the data is transmitted only to a computer at the owner/operator. In a further alternative, the data is transmitted only to a computer at the service provider.

Although the present invention has been described with reference to preferred embodiments, persons skilled in the art will recognize that changes may be made in form and detail without departing from the spirit and scope of the invention.

We claim:

1. An inbound automatic notification system comprising:
(a) at least one client processor configured to receive information about a plurality of assets;
(b) a notification processor configured to receive the information from the at least one client processor; and
(c) a database configured to receive the information from the notification processor.

2. The notification system of claim 1 wherein the notification processor is further configured to standardize the information.

3. The notification system of claim 1 wherein the notification processor is further configured to evaluate the information.

4. The notification system of claim 3 wherein the notification processor is further configured to identify actionable information based on the evaluation of the information, wherein the notification processor is configured to transmit a notification relating to the actionable information.

5. An outbound automatic notification system comprising:
a database configured to store information about a plurality of assets;
a processor in communication with the database, the processor configured to track information about the plurality of assets and transmit a notification upon a certain condition relating to one of the plurality of assets being met.

6. The notification system of claim 5 wherein the notification is an electronic communication.

7. The notification system of claim 5 wherein the notification is configured to be sent to an owner/operator.

8. The notification system of claim 5 wherein the notification is configured to be sent to a service provider.

9. A central asset management system comprising:
a central processor configured to track information from a plurality of notification systems, the information being relevant to managing each of a plurality of assets of a plurality of enterprises;
a notification processor configured to standardize the information from each of the plurality of notification systems, whereby the information is compatible with the central processor; and
a database configured to store asset information for the plurality of assets, the database in communication with the central processor.

10. The system of claim 9, wherein the notification processor is in communication with each of the plurality of notification systems through one of a plurality of modems.

11. The system of claim 9, wherein the notification processor is in communication with each of the plurality of notification systems through the Internet.

12. A method of processing information from a plurality of notification systems over a network, the method comprising:
receiving the information from one of a plurality of notification systems;
standardizing the information to be compatible with an asset management system; and
transmitting a notification relating to the information.

13. The method of claim 12 wherein transmitting the notification further comprises transmitting the notification to a database.

14. The method of claim 12 further comprising evaluating the information.

15. The method of claim 14 wherein evaluating the information further comprises identifying actionable information.

16. The method of claim 15 wherein transmitting the notification further comprises transmitting the notification directly to an owner/operator.

17. The method of claim 15 wherein transmitting the notification further comprises transmitting the notification directly to a service provider.

18. A method of transmitting notifications from an information management system, the method comprising:
tracking information relating to a plurality of assets;
identifying satisfaction of a pre-determined condition relating to the information; and
transmitting a notification relating to the satisfaction of the pre-determined condition.

19. The method of claim 18 wherein the pre-determined condition is based on defined criteria.

20. The method of claim 19 wherein the defined criteria are definable by a user.

21. The method of claim 19 wherein the defined criteria are pre-determined.

22. The method of claim 18 wherein the notification is an electronic communication.

23. The method of claim 18 where transmitting a notification further comprises transmitting the notification to an owner/operator.

24. The method of claim 18 where transmitting a notification further comprises transmitting the notification to a service provider.

25. The method of claim 18 where transmitting a notification further comprises transmitting the notification to a processor.
